(19) United States
(12) Patent Application Publication
(10) Pub. No.: US 2026/0220410 A1
(43) Pub. Date: Jul. 30, 2026

(54) IMAGE FORMING APPARATUS

(71) Applicant: CANON KABUSHIKI KAISHA, Tokyo (JP)

(72) Inventor: AKIHITO YOKOTE, Chiba (JP)

(21) Appl. No.: 19/457,411

(22) Filed: Jan. 23, 2026

(30) Foreign Application Priority Data
Jan. 24, 2025 (JP) 2025-010821

(51) Int. Cl. G06K 15/02; B41J 2/447; G03G 15/00; G03G 15/01; G03G 15/04; G03G 15/041

(52) U.S. Cl. CPC G06K 15/1868; B41J 2/447; G03G 15/04036; G03G 15/0415; G03G 15/50; G06K 15/1809; G06K 15/1871; G03G 15/011; G03G 15/0189

(57) ABSTRACT

An image forming apparatus configured to form an image on a sheet with toner includes an image processing module configured to generate bitmap data being composed of a plurality of pixels, and perform pixel thinning processing to the bitmap data based on a thinning rate, an image forming unit configured to form an image based on the bitmap data to which the pixel thinning processing is performed by the image processing module, a transfer unit configured to transfer the image formed by the image forming unit onto a sheet, a fixing unit configured to heat the image formed on the sheet to fix the image on the sheet, and a controller configured to determine the thinning rate based on a type of a sheet.

### BACKGROUND

### Field of the Technology

The present disclosure relates to an image forming apparatus which performs pixel thinning processing.

### Description of the Related Art

A general electrophotographic image forming apparatus uses toner to develop an electrostatic latent image formed by exposing a photosensitive member driven to rotate, to thereby form an image. The formed image is transferred onto a sheet, and a fixing device applies heat and pressure to the image so that the image is fixed to the sheet. The toner melts in a case where the heat is applied thereto by the fixing device, and is fixed to the sheet in a case where the pressure is applied thereto by the fixing device. For an exposure device for exposing the photosensitive member, an exposure head using light emitting elements such as light-emitting diodes (LEDs) or organic electro-luminescence (EL) elements or a scanning-type laser scanner is used. An emission pattern of the exposure device is determined based on image data representing the image to be printed.

In Japanese Patent Application Laid-open No. 2004-181868, there is disclosed a technology in which an exposure amount of a pixel of interest is adjusted in accordance with information on a pixel around the pixel of interest so that disconnection of a fine line is suppressed and image distortion is suppressed.

Incidentally, the fixing device has a limit in amount of toner fixable to the sheet. For example, in a case where images are successively printed on thick papers, heat is taken away from a heating unit provided in the fixing device by the thick paper or the toner, and thus the temperature at the time of image fixing is reduced. As a result, the toner is not sufficiently melted, and an adhesive strength between the toner and the sheet is lost, resulting in occurrence of fixing failure such as separation of toner after the fixing.

In view of the above, the inventors of the present disclosure have discussed to suppress fixing failure through use of the technology as described in Japanese Patent Application Laid-open No. 2004-181868.

### SUMMARY

An image forming apparatus configured to form an image on a sheet with toner according to one embodiment of the present disclosure includes an image processing module configured to generate bitmap data being composed of a plurality of pixels, and perform pixel thinning processing to the bitmap data based on a thinning rate, an image forming unit configured to form an image based on the bitmap data to which the pixel thinning processing is performed by the image processing module, a transfer unit configured to transfer the image formed by the image forming unit onto a sheet, a fixing unit configured to heat the image formed on the sheet to fix the image to the sheet, and a controller configured to determine the thinning rate to a first value in a case where the image is formed by the image forming unit on a sheet of a first type, and determine the thinning rate to a second value larger than the first value in a case where the image is formed by the image forming unit on a sheet of a second type having a basis weight larger than a basis weight of the sheet of the first type.

An image forming apparatus configured to form an image on a sheet with toner according to another embodiment of the present disclosure includes an image processing module configured to generate bitmap data being composed of a plurality of pixels, and perform pixel thinning processing to the bitmap data based on a thinning rate, an image forming unit configured to form an image, a transfer unit configured to transfer the image formed by the image forming unit onto a sheet, a fixing unit configured to heat the image formed on the sheet to fix the image on the sheet, and a controller configured to control, in a case where the image is formed by the image forming unit on a sheet of a first type, the image forming unit to form the image based on the bitmap data in which the pixel thinning processing is not performed, and control, in a case where the image is formed by the image forming unit on a sheet of a second type having a basis weight larger than a basis weight of the sheet of the first type, the image forming unit to form the image based on the bitmap data in which the pixel thinning processing is performed.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image forming apparatus.

FIG. 2A and FIG. 2B are explanatory diagrams of a photosensitive member and an exposure head.

FIG. 3A and FIG. 3B are explanatory diagrams of a printed circuit board.

FIG. 4 is an explanatory diagram of light emitting chips.

FIG. 5 is a plan view of a light emitting chip.

FIG. 6 is a cross-sectional view taken along the line A-A of FIG. 5.

FIG. 7 is a configuration diagram of an image controller.

FIG. 8 is a timing chart in a case in which control data is to be written.

FIG. 9 is a timing chart at the time of transmission of print image data.

FIG. 10 is a detailed functional configuration diagram of one light emitting chip.

FIG. 11 is an explanatory diagram of multiple exposure.

FIG. 12 is an explanatory graph of a potential attenuation characteristic.

FIG. 13 is a graph in which the potential attenuation characteristic is normalized by exposure energy.

FIG. 14 is a processing flowchart of edge preservation processing and pixel thinning processing.

FIG. 15 is an explanatory diagram of the edge preservation processing and the pixel thinning processing.

FIG. 16A, FIG. 16B, and FIG. 16C are explanatory diagrams of the edge preservation processing and the pixel thinning processing.

FIG. 17A, FIG. 17B, and FIG. 17C are explanatory diagrams of images to be obtained by the edge preservation processing and the pixel thinning processing.

FIG. 18 is an exemplary table of a relationship between sheet basis weight information or environmental information and a thinning rate.

FIG. 19 is a processing flowchart of the edge preservation processing and the pixel thinning processing.

FIG. 20A and FIG. 20B are exemplary diagrams of weighting filters.

FIG. 21 is an exemplary graph of an LUT.

FIG. 22A, FIG. 22B, and FIG. 22C are explanatory diagrams of a relationship among print image data, a potential contrast, and an on-sheet toner amount.

### DESCRIPTION OF THE EMBODIMENTS

At least one preferred embodiment of the present disclosure is described below with reference to the attached drawings. The at least one embodiment described below does not limit the appended claims. A plurality of features is described in the at least one embodiment, but the present disclosure does not necessarily require all of those plurality of features, and a plurality of features may be combined as appropriate. Further, in the attached drawings, the same or similar components are denoted by the same reference symbols, and redundant description thereof is omitted.

### <Image Forming Apparatus>

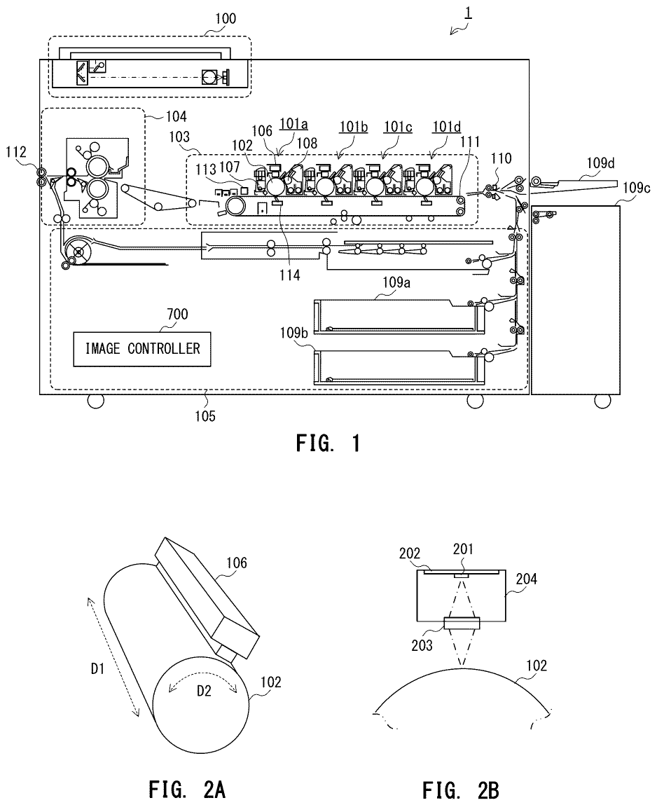

FIG. 1 is a configuration diagram of an image forming apparatus according to the at least one embodiment. An image forming apparatus 1 includes a reading portion 100, an image forming portion 103, a fixing portion 104, and a conveyance portion 105. The reading portion 100 optically reads an original placed on a platen to generate read image data. The image forming portion 103 forms an image on a sheet based on the read image data generated by the reading portion 100 or image data for printing acquired from an external apparatus via a network. The image forming apparatus 1 as described above is implemented by, for example, a copying machine, a multi-function machine, or a multi-function peripheral (MFP).

The image forming portion 103 includes a plurality of image forming units 101a, 101b, 101c, and 101d, a transfer belt 111 which conveys a sheet, and an optical sensor 113. The image forming units 101a, 101b, 101c, and 101d are used to form toner images in black (K), yellow (Y), magenta (M), and cyan (C), respectively. The image forming units 101a, 101b, 101c, and 101d are the same as one another in configuration, and are hereinafter also generally referred to as “image forming unit 101.”

The image forming unit 101 includes a photosensitive member 102, a charging device 107, an exposure head 106, and a developing device 108. The photosensitive member 102 is an image bearing member in a drum shape having a photosensitive layer on its surface. The photosensitive member 102 is rotationally driven in a clockwise direction of FIG. 1 about a drum shaft. The charging device 107 uniformly charges the surface of the rotating photosensitive member 102 in a predetermined polarity and at a predetermined electric potential. The exposure head 106 is an exposure device which exposes the uniformly charged surface of the photosensitive member 102 to form an electrostatic latent image on the surface of the photosensitive member 102. The exposure head 106 in the at least one embodiment has a configuration in which a plurality of light emitting elements is arranged in a planar form, details of which are described later.

The developing device 108 uses developer (for example, toner) to develop the electrostatic latent image formed on the photosensitive member 102, to thereby form a toner image on the surface of the photosensitive member 102. A transfer member 114 is provided at a position opposed to each photosensitive member 102 across the transfer belt 111. In a case where a transfer voltage is applied to the transfer member 114, the toner image formed on the surface of the photosensitive member 102 is sequentially transferred onto the sheet being conveyed on the transfer belt 111. The toner images on the four photosensitive members 102 are transferred onto the sheet in a superimposed manner. As a result, a color image including the four color components corresponding to black, yellow, magenta, and cyan is formed on the sheet. The optical sensor 113 optically reads an adjustment image transferred onto the sheet.

The conveyance portion 105 controls feeding of the sheet. The sheet can be fed from internal storage units 109a and 109b, an external storage unit 109c, and a manual feed unit 109d. The conveyance portion 105 feeds the sheet to a conveyance path from any one of the internal storage units 109a and 109b, the external storage unit 109c, and the manual feed unit 109d in accordance with an instruction. On the conveyance path, registration rollers 110 are provided. The fed sheet is conveyed to the registration rollers 110.

The registration rollers 110 correct skew feeding of the sheet and convey the sheet onto the transfer belt 111 at an appropriate timing so that the toner image on each photosensitive member 102 is transferred at a predetermined position on the sheet. As described above, the toner images are sequentially transferred onto the sheet in a superimposed manner while the sheet is being conveyed on the transfer belt 111. The sheet onto which the toner images are transferred is conveyed to the fixing portion 104. The fixing portion 104 applies heat and pressure to the sheet onto which the toner images are transferred, to thereby fix the toner images to the sheet. After the fixing of the toner images, the sheet is discharged to the outside of the image forming apparatus 1 by discharge rollers 112.

Inside the image forming apparatus 1, an image controller 700 which performs, on the read image data or the image data for printing, various types of image processing such as color space conversion, filtering, varying magnification, resolution conversion, and quantization is provided. The image controller 700 performs the image processing on the read image data or the image data for printing, to generate print image data for the image forming portion 103 to perform image forming. The image controller 700 includes an image processing module which performs the various types of image processing described above.

The image controller 700 corrects an image forming condition based on a reading result of the adjustment image obtained by the optical sensor 113. Details of the image controller 700 are described later.

In the above, the configuration in which the toner image is directly transferred onto the sheet on the transfer belt 111 from each photosensitive member 102 has been described, but the toner image may be indirectly transferred onto the sheet from each photosensitive member 102 via an intermediate transfer body. Moreover, in the above, the example in which the toner in the plurality of colors is used to form the color image has been described, but the technology in the at least one embodiment is also applicable to an image forming apparatus which uses toner in a single color to form a monochrome image.

### <Exposure Head>

FIG. 2A and FIG. 2B are explanatory diagrams of the photosensitive member 102 and the exposure head 106. FIG. 2A is a perspective view of the photosensitive member 102 and the exposure head 106. FIG. 2B is an explanatory diagram of an exposure position. The exposure head 106 includes a light-emitting element array 201 including the plurality of light emitting elements, a printed circuit board 202 on which the light-emitting element array 201 is mounted, a rod lens array 203, and a housing 204 which holds the rod lens array 203 and the printed circuit board 202.

The photosensitive member 102 has a drum shape as described above. The exposure head 106 is parallel with a drum axial direction D1 of the photosensitive member 102 in a length direction (array direction of light emitting elements), and is arranged such that a mounting surface of the rod lens array 203 opposes the surface of the photosensitive member 102. While the photosensitive member 102 is rotating in a circumferential direction D2, the light-emitting element array 201 (light emitting elements) of the exposure head 106 emits the light. The rod lens array 203 focuses the light emitted from the light-emitting element array 201 (light emitting elements) on the surface of the photosensitive member 102. The surface of the photosensitive member 102 is uniformly charged by the charging device 107, and an electric potential of a position at which the light is focused changes. The position at which the electric potential changes forms the electrostatic latent image.

In the light-emitting element array 201, the plurality of light emitting elements is arranged in a planar form. As the light emitting element, for example, an LED or an organic EL element is used. The drum axial direction D1 is a main scanning direction, and the circumferential direction D2 is a sub-scanning direction intersecting with the main scanning direction.

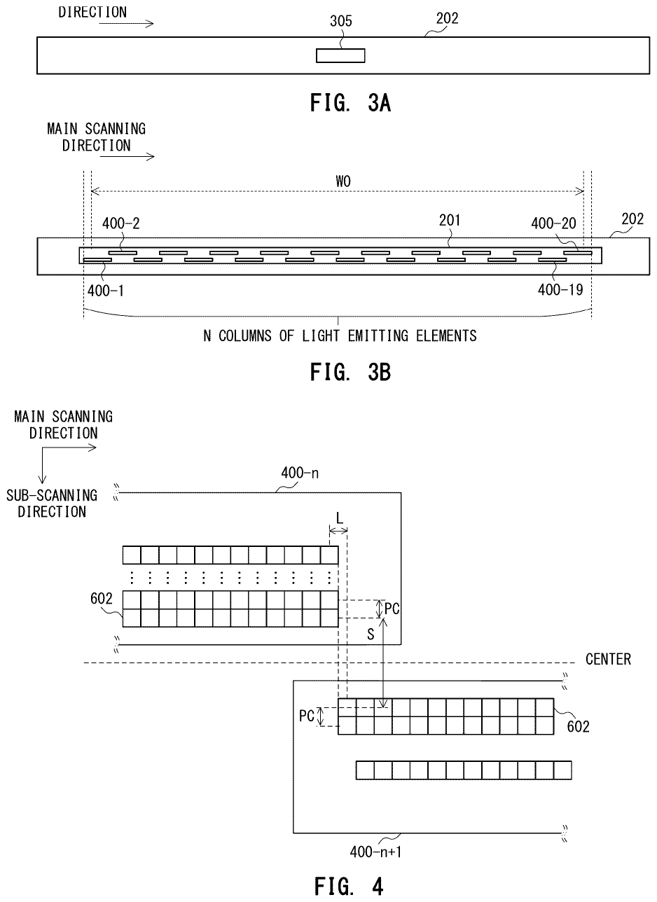

FIG. 3A and FIG. 3B are explanatory diagrams of the printed circuit board 202. On the printed circuit board 202, a connector 305 and the light-emitting element array 201 are mounted to surfaces different from each other. FIG. 3A shows the surface of the printed circuit board 202 to which the connector 305 is mounted. FIG. 3B shows the surface of the printed circuit board 202 to which the light-emitting element array 201 is mounted. The light-emitting element array 201 includes a plurality of light emitting chips 400 each of which includes the plurality of light emitting elements. In the at least one embodiment, the number of light emitting chips 400 is 20 (light emitting chips 400-1 to 400-20). The light emitting chips 400-1 to 400-20 are arranged in a staggered pattern in the main scanning direction.

As illustrated in FIG. 3B, a range occupied by all of the light emitting elements of the 20 light emitting chips 400-1 to 400-20 in the main scanning direction is wider than a range occupied by a maximum width W0 of the image indicated by the print image data. Thus, some light emitting elements positioned at both ends in the main scanning direction may not be used to expose the photosensitive member 102 as long as the positional displacement of the image is not detected. Each light emitting chip 400 of the printed circuit board 202 is connected to the image controller 700 via the connector 305.

For the convenience of description, a side on which branch numbers of the light emitting chips 400-1 to 400-20 arranged in the main scanning direction are smaller is hereinafter sometimes referred to as “left” and a side on which the branch numbers are larger is hereinafter sometimes referred to as “right.” For example, the light emitting chip 400-1 is the light emitting chip 400 at a left end, and the light emitting chip 400-20 is the light emitting chip at a right end. In FIG. 4, two light emitting chips of a light emitting chip 400-n and a light emitting chip 400-n+1 at the right end are illustrated as an example.

FIG. 4 is an explanatory diagram of the light emitting chips 400. The light-emitting element array 201 in the at least one embodiment includes, as a whole, the plurality of light emitting elements on N columns in the main scanning direction and on M rows in the sub-scanning direction. M and N are integers equal to or larger than 2. A number J (J=N/20) of light emitting elements 602 arranged on each row (main scanning direction) of one light emitting chip 400 is, for example, 748 (J=748). The number M of light emitting elements 602 arranged on each column (sub-scanning direction) of one light emitting chip 400 is, for example, 4 (M=4). That is, in the example in the at least one embodiment, the light emitting chip 400 includes a total of 2,992(=748×4) light emitting elements 602, which are the 748 light emitting elements in the main scanning direction (drum axial direction D1) and the 4 light emitting elements in the sub-scanning direction (circumferential direction D2).

A pitch PC between center points of the light emitting elements 602 next to each other in the sub-scanning direction is approximately 21.16 μm in a case where the resolution is, for example, 1,200 dpi. A pitch between the center points of the light emitting elements 602 next to each other in the main scanning direction is similarly, for example, approximately 21.16 μm. In this case, the length of the 748 light emitting elements 602 is approximately 15.8 mm in the main scanning direction.

FIG. 4 shows, for the convenience of description, an example in which the light emitting elements 602 of each light emitting chip 400 are completely arranged in a grid pattern, but the M (=4) light emitting elements 602 on each column are actually arranged in a staircase pattern. This point is described later.

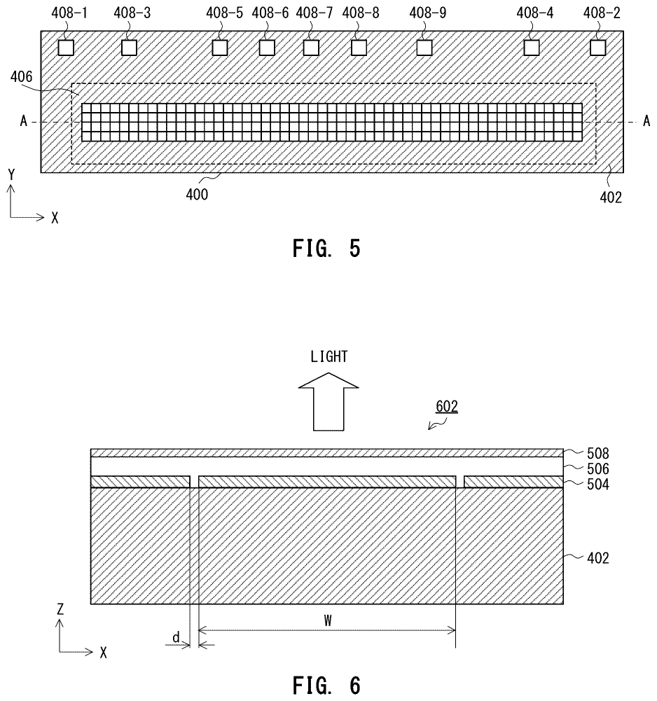

FIG. 5 is a plan view of the light emitting chip 400. The plurality of light emitting elements 602 is formed on a light emitting substrate 402 which is, for example, a silicon substrate. To the light emitting substrate 402, a circuit unit 406 which drives the plurality of light emitting elements 602 is also mounted. To the light emitting substrate 402, there are provided pads 408-1 to 408-9 to which signal lines which are used to communicate to and from the image controller 700, a power supply line which is used to connect to a power supply, and a ground line which is used to ground are connected. The signal lines, the power supply line, and the ground line are wires containing, for example, Au as a material.

FIG. 6 is a cross-sectional view taken along the line A-A of FIG. 5. On the light emitting substrate 402, a plurality of lower electrodes 504 is formed. Between two lower electrodes 504 next to each other, a gap having a length “d” is formed. A light emitting layer 506 is provided on the lower electrodes 504, and an upper electrode 508 is provided on the light emitting layer 506. The upper electrode 508 is one common electrode for the plurality of lower electrodes 504.

An electric potential difference is generated between the lower electrode 504 and the upper electrode 508, and hence an electric current flows from the lower electrode 504 to the upper electrode 508. As a result, the light emitting layer 506 emits light. Thus, one lower electrode 504 and a partial region of the light emitting layer 506 and the upper electrode 508 corresponding to this lower electrode 504 form one light emitting element 602. In the manner described above, the plurality of light emitting elements 602 is formed on the light emitting substrate 402.

As the light emitting layer 506, for example, an organic EL film is used. The upper electrode 508 is formed of a transparent electrode made of, for example, indium tin oxide (ITO) so as to transmit a predetermined wavelength (light emitting wavelength) of the light emitted from the light emitting layer 506. In the at least one embodiment, the entire upper electrode 508 transmits the light emitting wavelength of the light emitting layer 506, but the entire upper electrode 508 is not required to transmit the light emitting wavelength. Specifically, it is only required for a partial region through which the light from each light emitting element 602 passes to transmit the light emitting wavelength.

The light emitting layer 506 in the at least one embodiment is formed as one continuous light emitting layer 506, but a plurality of light emitting layers 506 each having a width equivalent to the width W of the lower electrode 504 may be formed in correspondence with the respective lower electrodes 504 thereon. Moreover, a first plurality of lower electrodes 504 out of the lower electrodes 504 of each light emitting chip 400 may be covered with a first light emitting layer 506, and a second plurality of lower electrodes 504 out of the lower electrodes 504 may be covered with a second light emitting layer 506. Moreover, a first upper electrode 508 may be formed in common in correspondence with the first plurality of lower electrodes 504 out of the lower electrodes 504 of each light emitting chip 400, and a second upper electrode 508 may be formed in common in correspondence with the second plurality of lower electrodes 504 out of the lower electrodes 504. Also in these configuration, one lower electrode 504 and the region of the light emitting layer 506 and the upper electrode 508 corresponding to this lower electrode 504 form one light emitting element 602.

### <Image Controller 700>

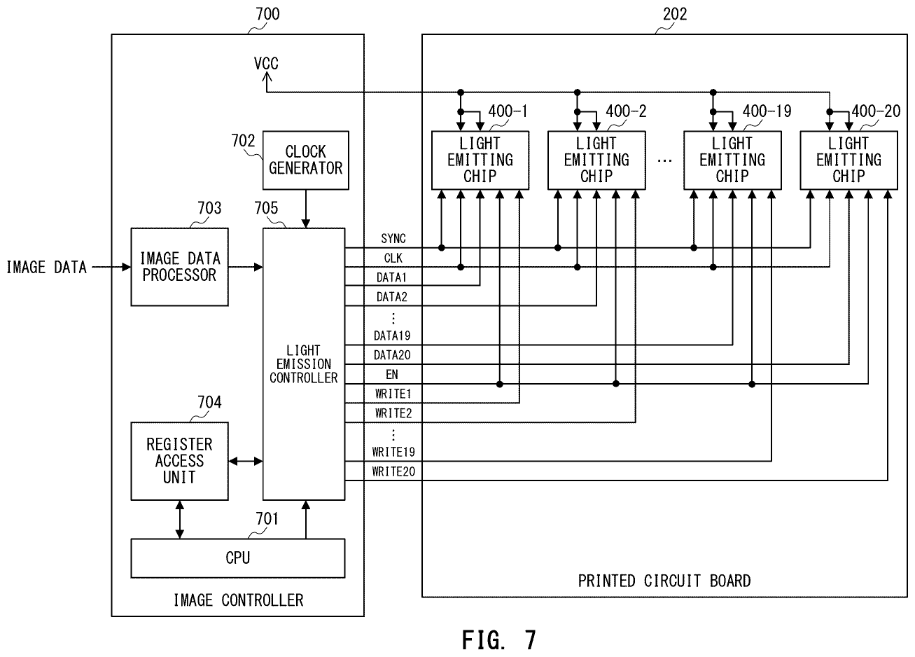

FIG. 7 is a configuration diagram of the image controller 700 which controls turning on and turning off of the light emitting chips 400. The image controller 700 can communicate to and from the printed circuit board 202 via the plurality of signal lines (wires). The image controller 700 includes a central processing unit (CPU) 701, a clock generator 702, an image data processor 703, a register access unit 704, and a light emission controller 705.

The light emission controller 705 forms an exposure device together with the exposure head 106. The light emission controller 705 terminates the signal lines to and from the printed circuit board 202. An n-th light emitting chip 400-n on the printed circuit board 202 is connected to the light emission controller 705 via a signal line DATAn and a signal line WRITEn. The signal line DATAn is a signal line for transmitting the print image data from the image controller 700 to the light emitting chip 400-n. The signal line WRITEn is a signal line used by the image controller 700 to write control data to a register of the light emitting chip 400-n.

Between the light emission controller 705 and each light emitting chip 400, one signal line CLK, one signal line SYNC, and one signal line EN are further provided. The signal line CLK transmits a clock signal used for the data transmission via the signal line DATAn and the signal line WRITEn. The clock generator 702 generates a reference clock signal, and transmits the generated reference clock signal to each component of the image controller 700. The light emission controller 705 transmits, to each light emitting chip 400 via the signal line CLK, a clock signal generated based on the reference clock signal acquired from the clock generator 702.

The CPU 701 controls the operation of the entire image forming apparatus 1. The image data processor 703 performs predetermined image processing on the read image data acquired from the reading portion 100 or the image data for printing acquired from the external apparatus. The image data processor 703 performs the image processing, to thereby generate binary bitmap image data (print image data) used for controlling light emission of the light emitting elements 602 of the light emitting chips 400 on the printed circuit board 202.

The image processing performed by the image data processor 703 includes, for example, raster conversion, tone correction, color conversion, and halftone processing (dithering processing). The image data processor 703 transmits the generated binary image data (print image data) to the light emission controller 705. The register access unit 704 receives, from the CPU 701, the control data to be written to the register in each light emitting chip 400, and transmits the received control data to the light emission controller 705.

The image forming apparatus 1 includes the exposure head 106 for each of the image forming units 101a to 101d. That is, in the at least one embodiment, four printed circuit boards 202 are provided. The image controller 700 is connected to those four printed circuit boards 202 and performs turning-on control for the plurality of light emitting elements 602 mounted to each of the four printed circuit boards 202. Accordingly, the image controller 700 generates and transmits four pieces of print image data corresponding to the respective four exposure heads 106. The four pieces of print image data are image data for forming a yellow image, image data for forming a magenta image, image data for forming a cyan image, and image data for forming a black image.

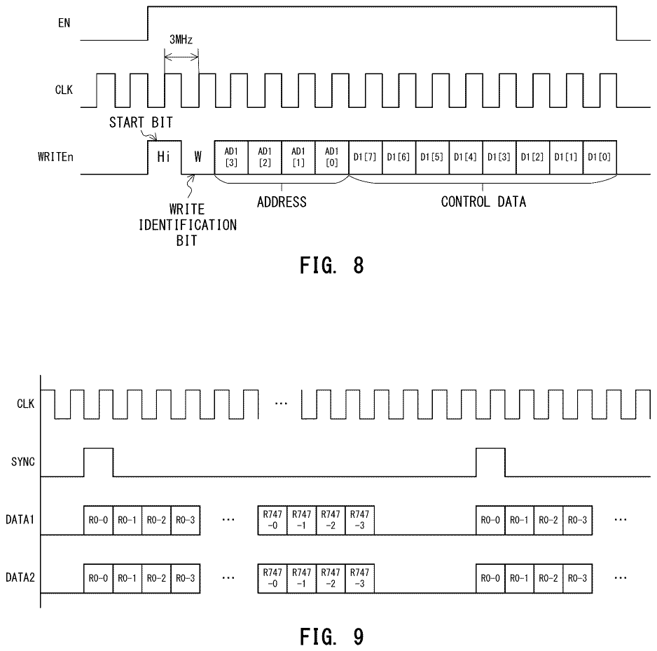

FIG. 8 is a timing chart in a case in which the control data is written to the register of each light emitting chip 400. FIG. 8 shows transition of a signal level of each signal line in the case in which the control data is to be written to the register of the light emitting chip 400. To the signal line EN, an enable signal which rises to a high level to indicate ongoing communication is transmitted during the communication. The light emission controller 705 transmits a start bit to the signal line WRITEn in synchronism with the rise of the enable signal. After that, the light emission controller 705 transmits a write identification bit indicating the write operation to the signal line WRITEn. Subsequently, the light emission controller 705 transmits an address (here, 4 bits) of the register to which the control data is to be written and the control data (here, 8 bits). The light emission controller 705 sets a frequency of the clock signal transmitted via the signal line CLK to, for example, 3 MHz at the time of the write to the register.

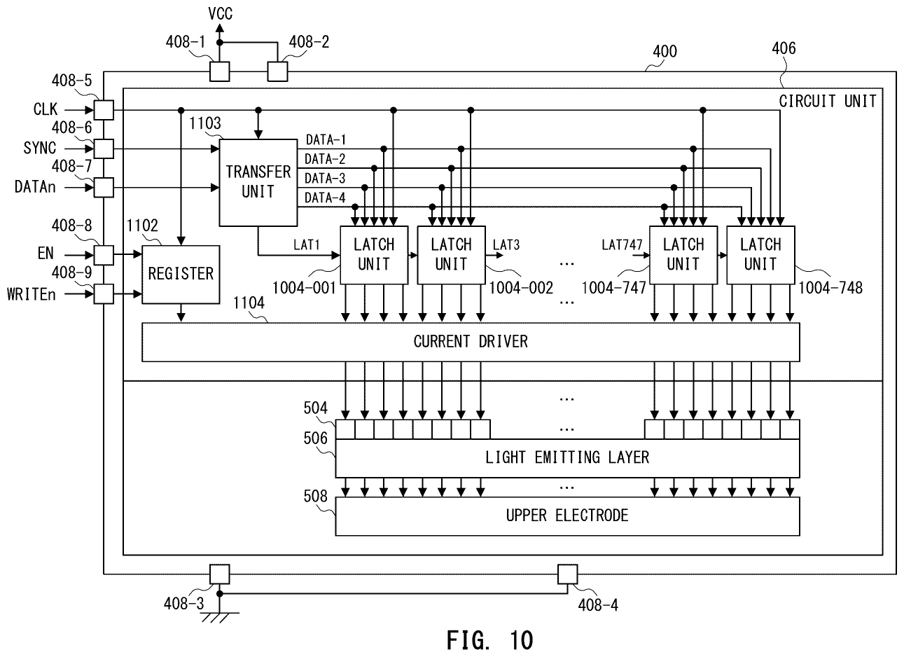

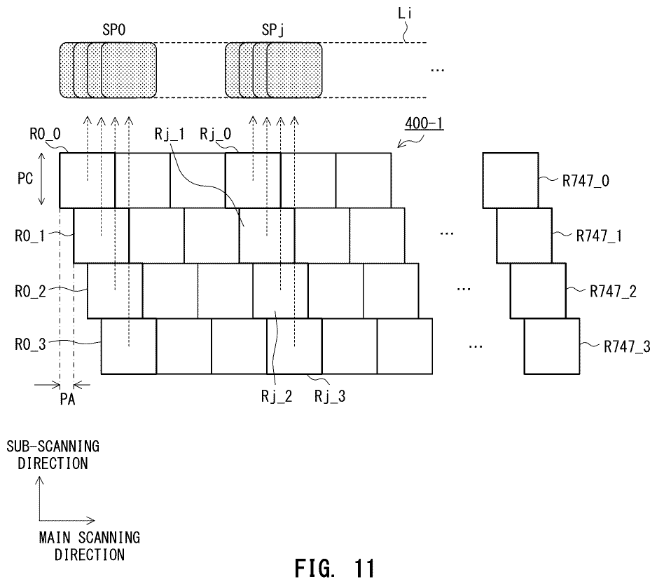

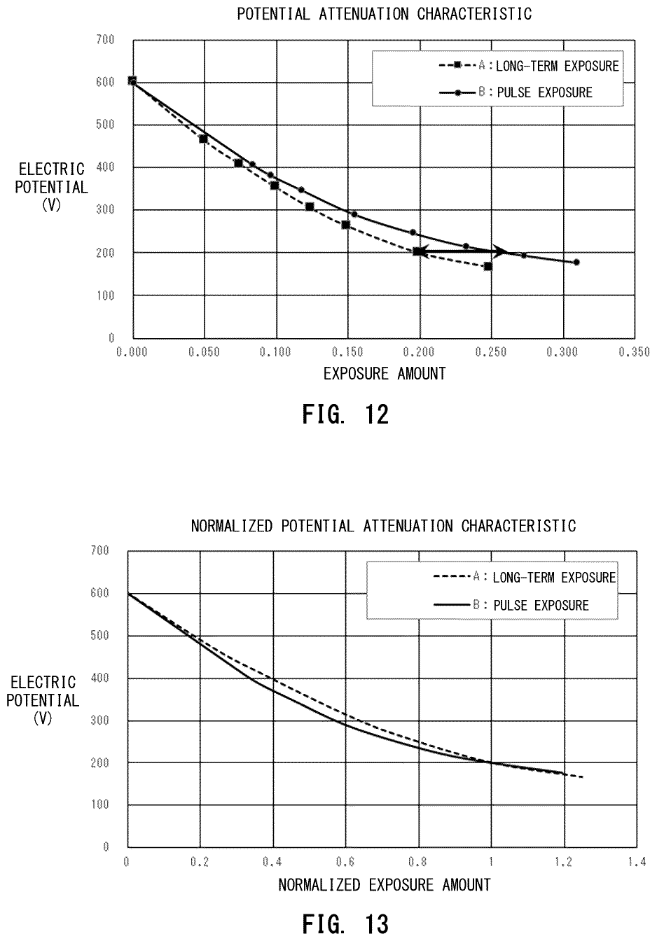

FIG. 9 is a timing chart at the time of the transmission of the print image data to each light emitting chip 400, and exemplifies transition of the signal level of each signal line. To the signal line SYNC, a cyclic line synchronization signal indicating an exposure timing of each line in the photosensitive member 102 is transmitted. In a case where a circumferential speed of the photosensitive member 102 is 200 mm/s and a resolution in the circumferential direction is 1,200 dpi (approximately 21.16 μm), the line synchronization signal is output at a cycle of approximately 105.8 μs.

The light emission controller 705 transmits, in synchronism with the rise of the line synchronization signal, the print image data via signal lines DATA1 to DATA20. Each light emitting chip 400 in the at least one embodiment includes the 2,992 light emitting elements 602, and hence it is required to transmit, to each light emitting chip 400, the print image data used to control the light emission (turning-on) of each of the 2,992 light emitting elements 602, within the cycle of approximately 105.8 μs. Thus, in the at least one embodiment, as illustrated in FIG. 9, at the time of the transmission of the print image data, the light emission controller 705 sets the frequency of the clock signal transmitted via the signal line CLK to 30 MHz.

FIG. 10 is a detailed functional configuration diagram of one light emitting chip 400 (n-th light emitting chip 400-n). The circuit unit 406 includes a register 1102, a transfer unit 1103, latch units 1004-001 to 1004-748 and a current driver 1104.

As described with reference to FIG. 5, the light emitting chip 400 includes the nine pads 408-1 to 408-9. To the pad 408-1 and the pad 408-2, a power supply voltage VCC is applied via the power supply line. To each portion of the circuit unit 406 of the light emitting chip 400, the power supply voltage VCC is applied via the pad 408-1 and the pad 408-2. The pad 408-3 and the pad 408-4 are grounded via the ground line. Each portion of the circuit unit 406 and the upper electrode 508 are grounded via the pad 408-3 and the pad 408-4.

To the pad 408-5, the signal line CLK is connected. The signal line CLK is connected to the transfer unit 1103, the register 1102, and the latch units 1004-001 to 1004-748 via the pad 408-5. To the pad 408-6, the signal line SYNC is connected. To the pad 408-7, the signal line DATAn is connected. The signal line SYNC and the signal line DATAn are connected to the transfer unit 1103 via the pad 408-6 and the pad 408-7, respectively. To the pad 408-8, the signal line EN is connected. To the pad 408-9, the signal line WRITEn is connected. The signal line EN and the signal line WRITEn are connected to the register 1102 via the pad 408-8 and the pad 408-9, respectively. In the register 1102, for example, control data indicating a light emission intensity of the light emitting element 602 is stored.

The transfer unit 1103 uses, as a start point, the line synchronization signal acquired from the signal line SYNC, to acquire, in synchronism with the clock signal acquired from the signal line CLK, from the signal line DATAn, the print image data including a series of pixel values each indicating the turning-on or the turning-off of one light emitting element 602. The transfer unit 1103 performs serial-parallel conversion on the series of pixel values serially acquired from the signal line DATAn in units of M (for example, M=4) pixel values.

For example, the transfer unit 1103 includes four cascade-connected D flip-flops. The transfer unit 1103 parallelizes pixel values DATA-1, DATA-2, DATA-3, and DATA-4 input during the four clocks and sequentially transmits the parallelized pixel values to the latch unit 1004-001 to 1004-748. Moreover, the transfer unit 1103 further includes four D flip-flops used to delay the line synchronization signal. The transfer unit 1103 outputs a first latch signal to the latch unit 1004-001 via a signal line LAT1 at a timing delayed by four clocks from the input of the line synchronization signal. The first latch signal is a signal obtained by, for example, delaying the line synchronization signal by the four clocks.

The k-th latch unit 1004-k (“k” is an integer of from 1 to 748) latches the four pixel values DATA-1, DATA-2, DATA-3, and DATA-4 input from the transfer unit 1103 simultaneously with the input of the k-th latch signal. Except for the last latch unit 1004-748, the k-th latch unit 1004-k delays the k-th latch signal by the amount corresponding to the four clocks and outputs the (k+1)-th latch signal to the latch unit 1004-(k+1) via the signal line LAT(k+1). The k-th latch unit 1004-k continues to output, to the current driver 1104, the drive signal based on the four latched pixel values during the signal cycle of the k-th latch signal.

For example, between the timing at which the first latch signal is input to the latch unit 1004-001 and the timing at which the second latch signal is input to the latch unit 1004-002, there exists a delay corresponding to the four clocks. Thus, while the latch unit 1004-001 outputs the drive signal based on the first to fourth pixel values to the current driver 1104, the latch unit 1004-002 outputs the drive signal based on the fifth to eighth pixel values to the current driver 1104.

Generally speaking, the latch unit 1004-k outputs the drive signal based on the (4k−3)-th to (4k)-th pixel values to the current driver 1104. Thus, in FIG. 10, the 2,992 drive signals used to control the drive of the 2,992(=748×4) light emitting elements 602 are output, to the current driver 1104, by the 748 latch units 1004-001 to 1004-748 substantially in parallel. Each drive signal is a binary signal indicating a low level or a high level.

The current driver 1104 includes 2,992 light emission drive circuits corresponding to the respective 2,992 light emitting elements 602 including the partial regions of the light emitting layer 506. Each light emission drive circuit applies a drive voltage corresponding to the light emission intensity indicated by the control data in the register 1102 to the light emitting layer 506 of the corresponding light emitting element 602 during a period in which the drive signal is at the high level implying ON (turning on) of the light emitting element 602. As a result, the electric current flows through the light emitting layer 506, resulting in the light emission of the light emitting element 602. The control data may indicate one individual light emission intensity for each light emitting element 602, may indicate one light emission intensity for each group of the light emitting elements 602, or may indicate one light emission intensity common to all of the light emitting elements 602.

### <Multiple-Exposure Control>

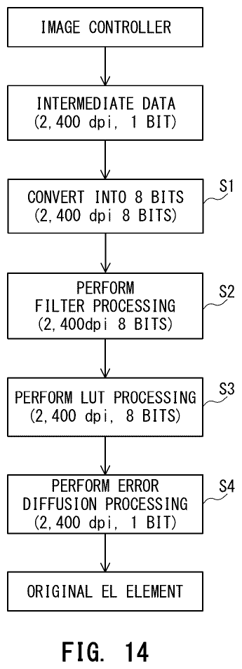

FIG. 4 shows the example in which the light emitting elements 602 of each light emitting chips 400 are arranged in a grid pattern, but the M light emitting elements 602 on each column are actually arranged in a staircase pattern at a fixed pitch. FIG. 11 is an explanatory diagram of multiple exposure by the light emitting elements 602 arranged in a staircase pattern. In FIG. 11, an arrangement of the light emitting elements 602 of the light emitting chip 400-1 in the case in which M=4 is partially illustrated as an example.

Rj_m (j={0, 1, . . . , 747} and m={0, 1, 2, 3}) indicates the light emitting element 602 on the j-th column from the left in the main scanning direction and on the m-th row from the top in the sub-scanning direction. A pitch PC of the light emitting element in the sub-scanning direction is determined by the size of the light emitting element 602, and is, for example, approximately 21.16 μm as described above. A pitch of the two light emitting elements next to each other out of the M light emitting elements on each column in the main scanning direction, that is, a pitch PA of the light emitting elements 602 in the main scanning direction is approximately 5 μm in a case of, for example, a resolution of 4,800 dpi.

As a result of arranging the four light emitting elements 602 on each column in a staircase pattern as described above, any two light emitting elements 602 next to each other out of those four light emitting elements 602 have a partially overlapping range in the main scanning direction. The four light emitting elements 602 on the column corresponding to each pixel position of the print image data sequentially emit light while the photosensitive member 102 is rotating, resulting in a spot corresponding to each pixel position being formed on the surface of the photosensitive member 102.

For example, four light emitting elements 602 having positional information of 4,800 dpi on a column corresponding to each pixel position of print image data having a resolution of 1,200 dpi sequentially emit light while the photosensitive member 102 is rotating. As a result, a spot of one pixel of 1,200 dpi corresponding to each pixel position of the print image data is formed on the surface of the photosensitive member 102. Further, in a case where the print image data has a resolution of 2,400 dpi, two light emitting elements 602 having positional information of 4,800 dpi on a column corresponding to each pixel position of the print image data overlap. As a result, a spot of one pixel of 2,400 dpi corresponding to each pixel position is formed on the surface of the photosensitive member 102.

In the example of FIG. 11, in a case where the print image data specifies turning on (ON) for the left end on an i-th line, the light emitting elements R0_0, R0_1, R0_2, and R0_3 sequentially emit light at the timings at which those light emitting elements oppose the line Li on the surface of the photosensitive member 102. As a result, a spot region at the left end of the line Li is subjected to the multiple exposure, resulting in formation of a spot SP0. Similarly, in a case where the print image data specifies turning on (ON) for a j-th line from the left on the i-th line, the light emitting elements Rj_0, Rj_1, Rj_2, and Rj_3 sequentially emit light at the timings at which those light emitting elements oppose the line Li on the surface of the photosensitive member 102. As a result, a j-th spot region from the left of the line Li is subjected to the multiple exposure, resulting in formation of a corresponding spot SPj.

As described above, in the at least one embodiment, the light emitting elements on the two columns next to each other in the main scanning direction occupy the ranges partially overlapping in the main scanning direction. Similarly, out of the two light emitting chips 400 next to each other in the main scanning direction, the light emitting elements on the right end column of the left light emitting chip 400 and the light emitting elements on the left end column of the right light emitting chip 400 also occupy ranges partially overlapping in the main scanning direction (see FIG. 3B).

For the entire 20 light emitting chips 400, the pitch PA of the light emitting elements 602 in the main scanning direction is constant (approximately 5 μm). The four light emitting elements on each column of those light emitting chips 400 sequentially emit light at appropriate timings, resulting in formation of a smooth line of the electrostatic latent image formed of a series of spots partially overlapping each other at a constant pitch on the surface of the photosensitive member 102. Such a line is continuously formed in the sub-scanning direction, resulting in formation of a two-dimensional electrostatic latent image on the surface of the photosensitive member 102.

Any one of the specific numerical values used in the description given above is an example, and each numerical value is not limited to each numerical value used in the at least one embodiment. For example, the number of light emitting chips 400 mounted to one printed circuit board 202 is not limited to 20, and is only required to be one or more. Moreover, the number of light emitting elements 602 included in each light emitting chip 400 is not limited to 2,992. In the at least one embodiment, one light emitting chip 400 includes the four sets of the 748 light emitting elements 602 arranged along the main scanning direction, but the number of sets is only required to be one or more. The light emitting elements 602 are arranged at the pitch of approximately 21.16 μm or approximately 5 μm corresponding to the resolution in the main scanning direction and the sub-scanning direction, but the arrangement pitch of the light emitting elements 602 is only required to be set in accordance with the resolution and the number of the light emitting elements 602. The number and the arrangement pitch of the light emitting elements 602 of the exposure head 106 are only required to be determined in accordance with the resolution and the image size of the image to be formed by the image forming apparatus 1.

### <Potential Attenuation Characteristic of Photosensitive Member>

FIG. 12 is an explanatory graph of a potential attenuation characteristic (EV curve) showing a relationship between the exposure amount (image forming condition) to the photosensitive member 102 and the surface potential of the photosensitive member 102. An image forming apparatus employing an analog exposure system is a system in which the reciprocity law of the photosensitive member is satisfied, but in a digital exposure system in which pulse exposure of a semiconductor laser or the like is used, the photosensitive member is in a reciprocity failure state. The reciprocity failure refers to a case of not satisfying the reciprocity law in which, in a case where the product of light illuminance and exposure time is constant, the amount of reacting substance is also the same, and is such a characteristic that complex factors of the exposure amount and the photosensitive member affect the formation of an electrostatic latent image.

In the digital exposure system in the at least one embodiment, an organic EL element is used as a light source. The organic EL element has such a characteristic that a light emission amount is lower than that of a semiconductor laser. Accordingly, an exposure time for one pixel becomes longer in the organic EL element than in the semiconductor laser. Specifically, while the exposure time of the semiconductor laser is 10 nanoseconds, the exposure time of the organic EL element is 10 microseconds or more. Accordingly, the organic EL element emits light for a long time period with a low light amount as compared to the case of the analog exposure system in order to ensure an amount of light required to attenuate the electric potential of the photosensitive member.

The broken line of FIG. 12 indicates an EV curve A in a case of using long-term exposure in the at least one embodiment. The solid line of FIG. 12 indicates an EV curve B in a case of using pulse exposure in the related art. In the at least one embodiment, the exposure time for one pixel is equal to or longer than 1,000 times the exposure time in the case of pulse exposure in the related art. In a case where the EV curve A of the long-term exposure in which the reciprocity law is substantially satisfied and the EV curve B of the pulse exposure in the reciprocity failure state are compared to each other, in a case of applying the same light amount (energy), the electric potential can be more attenuated in the case of the long-term exposure in which the reciprocity law is substantially satisfied.

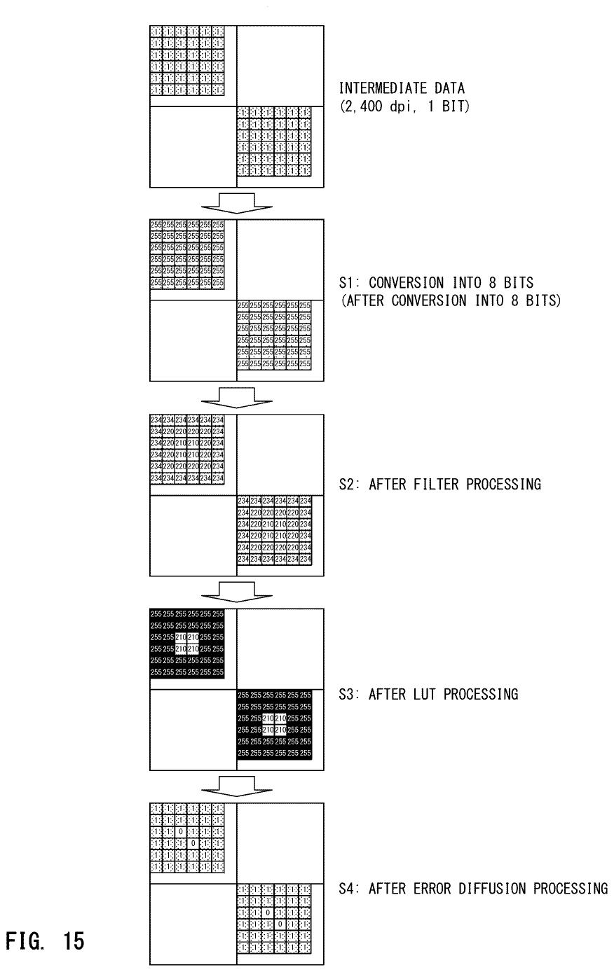

FIG. 13 is a graph in which the potential attenuation characteristic is normalized by exposure energy. In this case, under assumption that a photosensitive member surface potential (VD) after charging of the photosensitive member 102 is −600 V and a photosensitive member surface potential (VL) of a part of the photosensitive member 102, which is exposed so as to obtain a set solid image density, is −200 V, the potential attenuation characteristic is normalized by the exposure energy. As shown in FIG. 13, the EV curve A in the case of the long-term exposure has a more linear characteristic than that of the EV curve B in the case of the pulse exposure. In a case where the normalized potential attenuation characteristic becomes a characteristic as the EV curve A of FIG. 13, it becomes difficult to reproduce a highlight region or an extra fine line as a characteristic of an electrophotographic system, and hence the quality of the image is reduced.

### <Edge Preservation Processing and Pixel Thinning Processing>

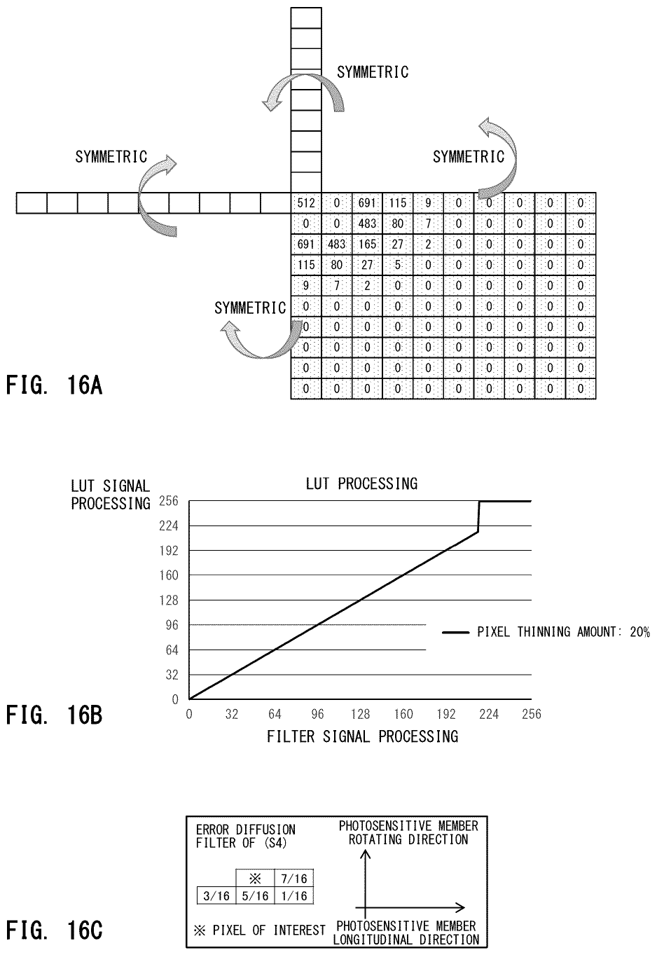

Description is given of pixel thinning processing in which, in order to prevent such reduction in image quality, exposure to a predetermined number of pixels from the pixels of the entire image is restricted. The pixel thinning processing of the pixels is performed through use of error diffusion processing. However, in a case where the error diffusion processing is performed as it is, the pixels are thinned in a random manner. In a case where pixels of an edge part of a dot or a line are thinned by the error diffusion processing, the shape of the image varies, resulting in decrease in reproducibility improvement effect or reduction in graininess. Accordingly, in the at least one embodiment, edge preservation processing is performed together with the pixel thinning processing of pixels so that the reproducibility improvement effect and the graininess are maintained while the variations in shape of the image are suppressed. In the edge preservation processing, pixels in the edge part are excluded from the pixels to be thinned such that the edge part present at a boundary part of the image is prevented from being thinned. FIG. 14 is a processing flowchart of the edge preservation processing and the pixel thinning processing.

The image controller 700 causes the image data processor 703 to perform tone correction processing and dithering processing on the read image data or the image data for printing acquired from the reading portion 100 or an external device, to thereby generate intermediate data (bitmap data) of 1 bit. In the processing of FIG. 14, the intermediate data represents an image of 2,400 dpi.

The image controller 700 converts the intermediate data into 8 bits (Step S1). As a result, each pixel value of the image can take a value of from 0 to 255. The image controller 700 performs, for each pixel, weighting filter processing of increasing a pixel value of an edge of the image with reference to a surrounding pixel, on the intermediate data converted into 8 bits (Step S2). The image controller 700 performs look-up table (LUT) processing to change a pixel value of a pixel having a pixel value of the intermediate data after being performed the weighting filter processing of a threshold value or more to a fixed value, in this case, “255” (Step S3). The image controller 700 thins pixels having pixel values other than the fixed value (other than “255”) by the error diffusion processing in accordance with an amount of increase in light amount (Step S4).

FIG. 15 and FIG. 16A to FIG. 16C are explanatory diagrams of such edge preservation processing and pixel thinning processing. FIG. 15 shows transition of the pixel value of the intermediate data by each type of processing of FIG. 14. FIG. 16A to FIG. 16C show a weighting filter (FIG. 16A), an LUT (FIG. 16B), and an error diffusion filter (FIG. 16C).

The image controller 700 performs the weighting filter processing of Step S2 through use of the weighting filter of FIG. 16A. The image controller 700 performs the LUT processing of Step S3 through use of the LUT of FIG. 16B. In the LUT processing, the pixel value of the pixel having the pixel value of the intermediate data after being performed the weighting filter processing of a threshold value or more is changed to “255.” In this case, the threshold value is set to “220.” The pixel value of the pixel having the pixel value of “220” or more is changed to “255.” The image controller 700 performs the error diffusion processing of Step S4 through use of the error diffusion filter of FIG. 16C. In this case, in order to increase the highlight potential contrast, the amount of increase in light amount is set to 20%, and the amount of pixels to be thinned in accordance therewith is set to 20%. The potential contrast is adjusted by controlling the exposure amount. That is, the exposure amount and the potential contrast are examples of the image forming condition.

With the above-mentioned processing, it is possible to restrict exposure to pixels in a pixel thinning amount corresponding to a thinning rate of the pixels, with respect to pixels excluding pixels in the edge part of the image. The pixel in the edge part of the image has a pixel value that is the threshold value or more due to the weighting filter, and is thus excluded from the target of the pixel thinning processing. As a result, the potential contrast can be reduced more than the variation range of the exposure amount. Accordingly, it is possible to adjust the toner amount so as to prevent image density adjustment failure or fixing failure.

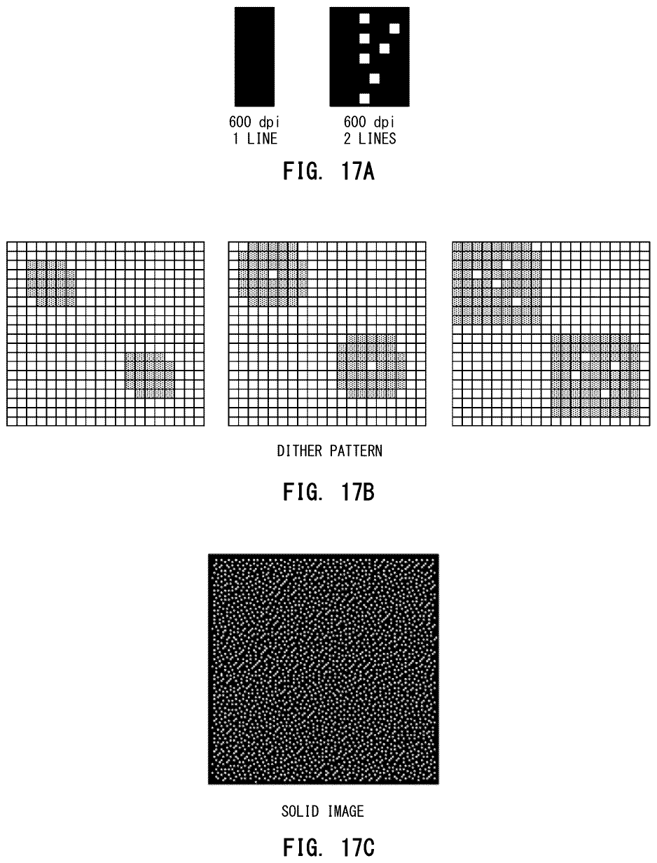

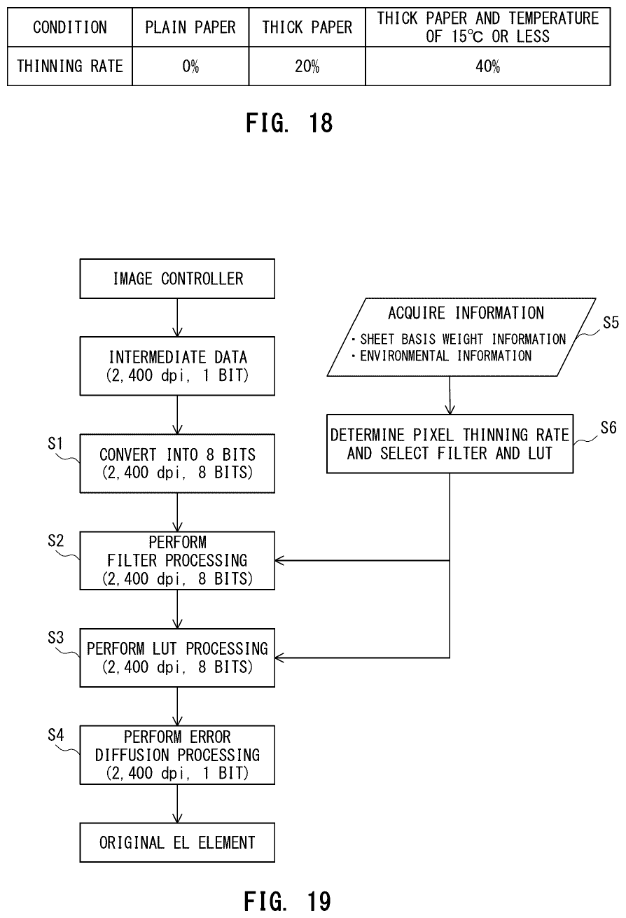

FIG. 17A to FIG. 17C are explanatory diagrams of images obtained by such edge preservation processing and pixel thinning processing. FIG. 17A exemplifies an exposure pattern (exposure position) of a line pattern, FIG. 17B exemplifies an exposure pattern (exposure position) of a dither pattern, and FIG. 17C exemplifies an exposure pattern (exposure position) of a solid image. In the images, black and hatched parts are exposed pixels (exposure portions), and a white part is an unexposed pixel (non-exposure portion).

As shown in the line pattern and the dither pattern, pixels are not thinned in an extra fine line and a highlight image. That is, pixel thinning is not performed unless the image has a predetermined size or more. Further, as is clear from each of the exposure patterns of the line pattern, the dither pattern, and the solid image, with the weighting filter processing of Step S2 and the LUT processing of Step S3, the pixel value of the edge part of the image is “255.” Accordingly, the edge part is not performed the pixel thinning processing by the error diffusion processing of Step S4, and the pixel value of the edge part is consequently preserved.

The image controller 700 generates print image data from the intermediate data after being performed pixel thinning processing, and performs exposure control of the exposure head 106 in accordance with the print image data. As a result, the image forming unit 101 forms an electrostatic latent image on the photosensitive member 102. The processing of FIG. 14 is performed on each of image data pieces of the respective colors of yellow, magenta, cyan, and black. As described above, the image controller 700 performs thinning of pixels by 20% from the intermediate data (bitmap data) after being performed dithering processing while preserving the edge in units of one pixel of 2,400 dpi, which is a resolution higher than that of the dithering processing. In this manner, the potential contrast is consequently reduced as well without reducing the image quality, and the amount of toner to be consumed can be reduced. In the at least one embodiment, the pixel thinning processing is performed by binarization processing using error diffusion, but the binarization processing is not limited to the error diffusion method. The binarization processing can also be performed by a binarization processing method of a dot dispersed type, such as a blue-noise mask method or an FM screen method.

### <Adjustment of Edge Preservation Processing and Pixel Thinning Processing>

The edge preservation processing and the pixel thinning processing can be changed in accordance with sheet basis weight information and environmental information. In a case where the potential contrast is desired to be reduced than the potential contrast that can be achieved only by the light amount adjustment of the exposure head 106, the pixel thinning processing of pixels is performed. Further, the thinning rate is also not limited to 20% described above, and the thinning rate of pixels can also be increased or decreased as appropriate in accordance with the required amount of toner, that is, the amount of potential contrast desired to be set.

A case in which the amount of toner is desired to be reduced is a case in which an image is formed on thick paper in which fixing failure is liable to occur as described above. The fixing failure is more liable to occur in a case where the image forming apparatus 1 is used under a low temperature environment. FIG. 18 is an explanatory table for showing a relationship between such a condition such as a sheet basis weight or environmental information and the thinning rate. In a case where printing is performed on plain paper, the thinning rate of pixels is 0%. In a case where printing is performed on thick paper having a high basis weight, heat of the fixing portion 104 is easily taken away, and hence the thinning rate of pixels is set to 20%. In this case, the plain paper is, for example, a sheet having a basis weight of from 90 g/m² to 128 g/m², and the thick paper is, for example, a sheet having a basis weight of from 129 g/m² to 350 g/m². Further, in a case where the usage environment of the image forming apparatus 1 is a low temperature environment, heat of the fixing portion 104 during successive printing is less liable to be recovered, and hence the thinning rate of pixels is set to 40%. The present disclosure does not limit the thinning rate to the above-mentioned numerical values. For example, the thinning rate of plain paper may be set to 10%, and the thinning rate of thick paper may be set to 25%. Moreover, for example, the thinning rate in the case of thick paper and a low temperature environment may be set to 50%.

Further, although not shown as an example in FIG. 18, the amount of thinning of pixels corresponding to the thinning rate is also determined based on the surface characteristics of the sheet. For example, in a case where printing is performed on a sheet having deep surface unevenness (for example, embossed paper), heat of the fixing portion 104 is taken away and heat is less likely to be transmitted to toner that has entered a surface recessed portion of the sheet, and hence the thinning rate of pixels is set to 20% or more. It is required to reduce the amount of toner in order to maintain productivity, but when it is desired not to reduce the amount of toner, it is possible to perform printing while ensuring a recovery time of heat of the fixing portion 104 by reducing the productivity without changing the thinning rate. In this case, it is possible to set the thinning rate by the user. Further, other than the purpose of preventing fixing failure, even at the time of a toner saving mode in which the toner usage amount is desired to be reduced, it is possible to restrict the thinning rate or the thinning amount. It is also possible to determine the thinning rate of pixels in accordance with the number of sheets to be subjected to successive printing. For example, in a case where images are printed on a large number of sheets, the temperature of the fixing portion 104 tends to be reduced as the number of sheets is increased. Accordingly, as the number of sheets to be subjected to successive printing is increased, the thinning rate of pixels is set to be higher.

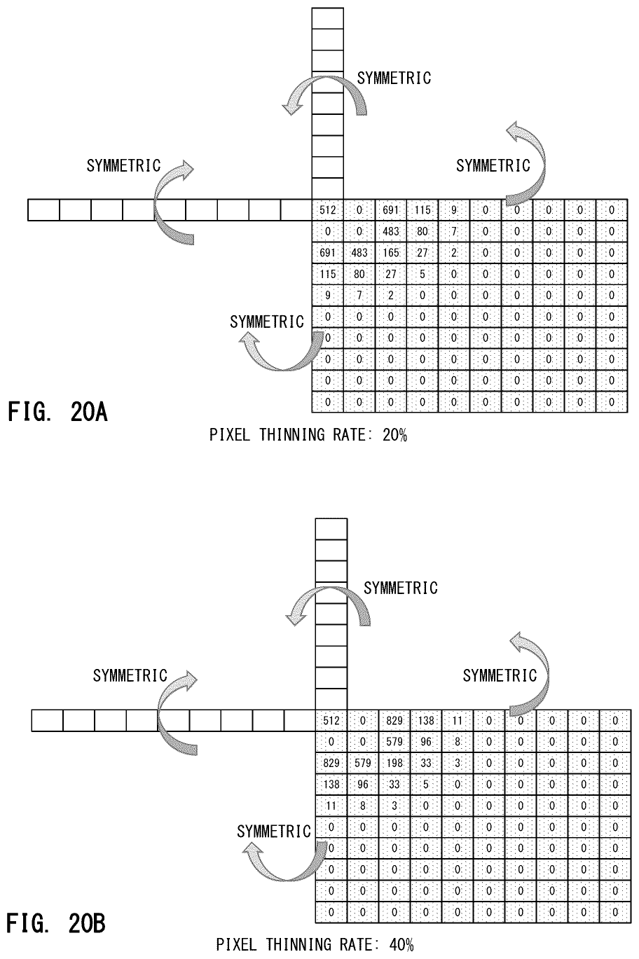

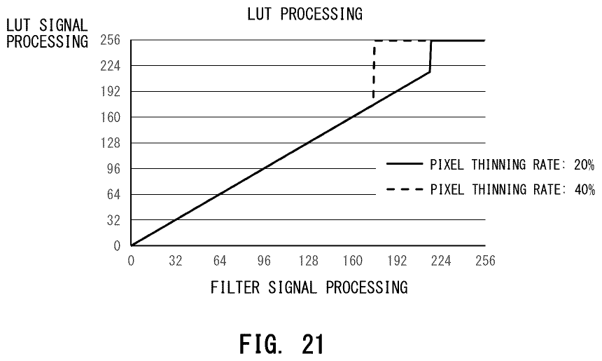

FIG. 19 is a processing flowchart of the edge preservation processing and the pixel thinning processing that allow the thinning rate to be adjusted. FIG. 20A and FIG. 20B are exemplary diagrams of the weighting filters. FIG. 21 is an exemplary graph of the LUT. Description of the processing steps of Step S1 to Step S4 is omitted because the processing steps are similar to those in the case of FIG. 14.

The image controller 700 acquires information relating to the basis weight of the sheet to be subjected to printing, environmental information (for example, temperature or humidity) detected by an environment sensor provided in the image forming apparatus 1, information on a printing job, or the like (Step S5). The image controller 700 determines the thinning rate of pixels in accordance with the information acquired in Step S5, and selects the weighting filter and the LUT to be used (Step S6).

The thinning rate is determined by, for example, preparing in advance a table including information as shown in FIG. 18, and selecting the pixel thinning rate that matches the information acquired in the processing step of Step S5 from the table. With the processing step of Step S6, the weighting filter of any one of FIG. 20A and FIG. 20B and the LUT shown in FIG. 21 corresponding to the pixel thinning rate are selected. FIG. 20A is a weighting filter selected in a case where the pixel thinning rate is 20%, and FIG. 20B is a weighting filter selected in a case where the pixel thinning rate is 40%. The solid line of FIG. 21 indicates the LUT selected in a case where the pixel thinning rate is 20%, and the broken line of FIG. 21 indicates the LUT selected in a case where the pixel thinning rate is 40%. The processing step of Step S2 is performed by the weighting filter selected in Step S6. The processing step of Step S3 is performed by the LUT selected in Step S6. With the LUT, the threshold value to be compared to the pixel value in the processing step of Step S3 is determined.

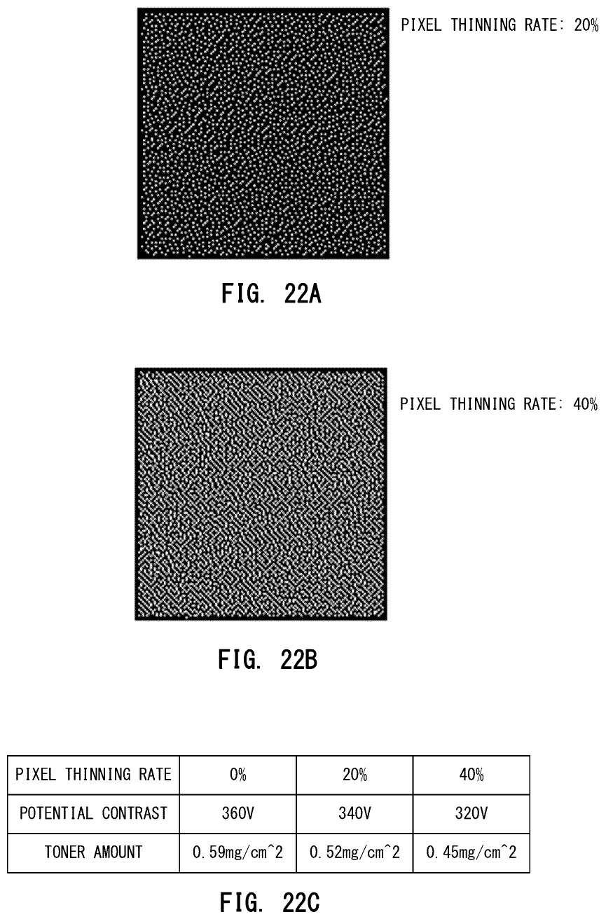

FIG. 22A to FIG. 22C are explanatory diagram of a relationship among the print image data, the potential contrast, and the on-sheet toner amount obtained in a case where the pixel thinning rate is changed to 0% (no pixel thinning processing), 20%, and 40%. In a case where a solid image is to be printed, an image (FIG. 22A) having a pixel thinning rate of 20% is higher in image density than an image (FIG. 22B) having a pixel thinning rate of 40%. As shown in FIG. 22C, as the pixel thinning rate becomes higher, the potential contrast becomes lower, and the amount of toner on the sheet is reduced. As described above, with the edge preservation and pixel thinning processing corresponding to the setting of the amount of toner to be achieved and the potential contrast to be achieved being performed in accordance with the printing, the image can be printed without reducing the image quality.

As described above, the image forming apparatus 1 according to the at least one embodiment performs weighting filter processing on the intermediate data to preserve pixels in the edge part of the image, and performs pixel thinning processing in accordance with the pixel thinning rate. The pixel thinning rate is determined based on the sheet basis weight information and the environmental information. In this manner, it is possible to reduce the potential contrast to a required potential contrast. With the pixel thinning rate being adjusted, without replacing the combination of the exposure head 106 and the photosensitive member 102, a wide toner amount setting and a wide potential contrast setting can be achieved. Accordingly, it is possible to reduce the amount of toner on the sheet and appropriately suppress the fixing failure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-010821, filed Jan. 24, 2025, which is hereby incorporated by reference herein in its entirety.

What is claimed is:

1. An image forming apparatus configured to form an image on a sheet with toner, the image forming apparatus comprising:
an image processing module configured to generate bitmap data being composed of a plurality of pixels, and perform pixel thinning processing to the bitmap data based on a thinning rate;
an image forming unit configured to form an image based on the bitmap data to which the pixel thinning processing is performed by the image processing module;
a transfer unit configured to transfer the image formed by the image forming unit onto a sheet;
a fixing unit configured to heat the image formed on the sheet to fix the image on the sheet; and
a controller configured to determine the thinning rate to a first value in a case where the image is formed by the image forming unit on a sheet of a first type, and determine the thinning rate to a second value larger than the first value in a case where the image is formed by the image forming unit on a sheet of a second type having a basis weight larger than a basis weight of the sheet of the first type.

2. The image forming apparatus according to claim 1, wherein the controller is configured to control the thinning rate based on information relating to a basis weight of a sheet to which the image is to be formed by the image forming unit and environmental information detected by a sensor provided in the image forming apparatus.

3. The image forming apparatus according to claim 1,
wherein the image forming unit includes a photosensitive member, a charging device configured to charge the photosensitive member, an exposure device configured to expose the photosensitive member charged by the charging device to form an electrostatic latent image, and a developing device configured to develop the electrostatic latent image with toner, and
wherein the exposure of the photosensitive member by the exposure device is controlled based on the bitmap data to which the pixel thinning processing is performed by the image processing module.

4. The image forming apparatus according to claim 1, wherein the image processing module is configured to determine an edge part in the bitmap data, and perform the pixel thinning processing to pixels excluding pixels of the edge part in the bitmap data.

5. The image forming apparatus according to claim 4,
wherein the image processing module is configured to perform filter processing of increasing a pixel value of each pixel of the bitmap data based on a filter, and
wherein the image processing module is configured to determine the edge part in the bitmap data after the filter processing is performed.

6. The image forming apparatus according to claim 5, wherein the image processing module is configured to select the filter in accordance with the thinning rate.

7. The image forming apparatus according to claim 1, wherein the image processing module is configured to change a pixel value of a threshold value or more to a fixed value, and perform the pixel thinning processing to pixels having values other than the fixed value.

8. The image forming apparatus according to claim 7, wherein the image processing module is configured to determine the threshold value in accordance with the thinning rate.

9. The image forming apparatus according to claim 1, wherein the controller is configured to determine the thinning rate based on the number of sheets to be subjected to successive printing.

10. An image forming apparatus configured to form an image on a sheet with toner, the image forming apparatus comprising:
an image processing module configured to generate bitmap data being composed of a plurality of pixels, and perform pixel thinning processing to the bitmap data based on a thinning rate;
an image forming unit configured to form an image;
a transfer unit configured to transfer the image formed by the image forming unit onto a sheet;
a fixing unit configured to heat the image formed on the sheet to fix the image on the sheet; and
a controller configured to:
control, in a case where the image is formed by the image forming unit on a sheet of a first type, the image forming unit to form the image based on the bitmap data in which the pixel thinning processing is not performed, and
control, in a case where the image is formed by the image forming unit on a sheet of a second type having a basis weight larger than a basis weight of the sheet of the first type, the image forming unit to form the image based on the bitmap data in which the pixel thinning processing is performed.

11. The image forming apparatus according to claim 10, wherein the controller is configured to determine the thinning rate based on environmental information detected by a sensor provided in the image forming apparatus.

12. The image forming apparatus according to claim 10,
wherein the image forming unit includes a photosensitive member, a charging device configured to charge the photosensitive member, an exposure device configured to expose the photosensitive member charged by the charging device to form an electrostatic latent image, and a developing device configured to develop the electrostatic latent image with toner, and
wherein the exposure of the photosensitive member by the exposure device is controlled, in a case where the image is formed by the image forming unit on the sheet of the second type, based on the bitmap data to which the pixel thinning processing is performed by the image processing module.

13. The image forming apparatus according to claim 10, wherein the image processing module is configured to determine an edge part in the bitmap data, and perform the pixel thinning processing to pixels excluding pixels of the edge part in the bitmap data.

14. The image forming apparatus according to claim 13,
wherein the image processing module is configured to perform filter processing of increasing a pixel value of each pixel of the bitmap data based on a filter, and
wherein the image processing module is configured to determine the edge part in the bitmap data after the filter processing is performed.

15. The image forming apparatus according to claim 14, wherein the image processing module is configured to select the filter in accordance with the thinning rate.

16. The image forming apparatus according to claim 10, wherein the image processing module is configured to change a pixel value of a threshold value or more to a fixed value, and perform the pixel thinning processing to pixels having values other than the fixed value.

17. The image forming apparatus according to claim 16, wherein the image processing module is configured to determine the threshold value in accordance with the thinning rate.

18. The image forming apparatus according to claim 10, wherein the controller is configured to determine the thinning rate based on the number of sheets to be subjected to successive printing.
